(19) United States
(12) Patent Application Publication
(10) Pub. No.: US 2011/0099830 A1
(43) Pub. Date: May 5, 2011

(54) TOOL POSITIONING SYSTEM

(75) Inventor: Steven Conrad, Tigard, OR (US)

(73) Assignee: SILTRONIC CORPORATION, Portland, OR (US)

(21) Appl. No.: 12/899,449

(22) Filed: Oct. 6, 2010

Related U.S. Application Data
(60) Provisional application No. 61/256,764, filed on Oct. 30, 2009.

(51) Int. Cl. G01B 3/18

(52) U.S. Cl. 33/831

(57) ABSTRACT

A system and a process are provided for positioning a tool relative to a surface. The system may include a mount fixed in location relative to the surface. A positioning assembly may be coupled to the mount that holds the tool adjacent the surface and moves the tool relative to the surface. The positioning assembly may move the tool to a reference location, identify such location, and then move to the tool to an operating position defined at a specified distance from the reference position. The positioning assembly may include a strain gauge to identify contact of the tool with the surface at the reference location via an indicator coupled to the strain gauge. The positioning assembly may also include a micrometer attached at its body to the mount and a spindle operable to move the tool. Fixtures couple the micrometer, strain gauge and tool to maintain fixed relative positions except for calibrated movement of the tool.

### CROSS-REFERENCE TO RELATED APPLICATION

This application claims priority to U.S. Provisional Patent Application Ser. No. 61/256,764, filed Oct. 30, 2009, which is hereby incorporated by reference.

### TECHNICAL FIELD

The present invention relates to a system for positioning a tool relative to a surface and a method for using the system. The present invention may have particular application where the surface and the portion of the tool to be positioned relative to the surface are not accessible for direct measurement of the distance between the two.

### BACKGROUND

In a manufacturing or other process, a tool may need to be positioned with respect to a surface of an object. For example, the tool may be a sensor, such as a thermocouple that is placed inside the chamber of a reactor where a semiconductor wafer is being processed. The thermocouple may be positioned with respect to a lower surface of a susceptor that underlies the wafer.

In a Bernoulli-type reactor made by ASM, a manufacturer of semiconductor equipment, the center thermocouple (TC) is housed beneath the susceptor in a straight shaft approximately 0.25-inches in diameter and 16 inches in length. A technician installs the center TC in a vertical and upward fashion from underneath the chamber. The center TC is then held in place by the compression of an o-ring and locknut assembly, for example, an Ultra Torr fitting. Once installed, only a small section (approximately 1 inch) of the bottom plug end of the center TC is visible and accessible to the technician. Inside the chamber, the center TC protrudes through a center-mounted clear quartz shaft that supports a graphite susceptor.

Adjacent the location for the tip of the center TC, the susceptor typically includes a small pocket, centered on the lower surface. The pocket is approximately 1-mm deep and the center TC tip is positioned in the pocket at a specified distance below the surface of the pocket. Approximately 2-mm to 3-mm of the center TC tip is exposed to the ambient chamber environment in a preferred TC installation. This exposure to the ambient temperature tends to make information from the center TC more significant than the other TCs (typically adjacent the front, side(s), and rear of the susceptor) for the purposes of control of wafer processing.

The precision of the center TC installation can affect multiple components of wafer processing, including: process control, production capability, yield, costs for parts replacement, and equipment status (online or down for maintenance). One problem with improper location of the TC is that it can cause fusion of the TC to the susceptor.

Typically, a gap in the range of 0.100-mm to 0.150-mm is set between the TC's tip and the susceptor's bottom surface within the pocket. In at least some reactors, the technician must set this gap while having access only to the bottom plug end of the TC. Two difficulties inhere in setting this gap: locating the base reference position for the TC, which is when the TC tip is in contact with the lower surface of the susceptor, and then setting an appropriate gap, i.e., moving the TC away from the base reference position to a specified distance with 0.005 mm accuracy.

The situation could be improved if the base reference point were acquired with higher accuracy and the TC were moved with a higher precision of gap measurement than at present. Preferably such an improvement would provide consistent and repeatable performance.

### SUMMARY

The present disclosure is directed toward a system and a process for positioning a tool relative to a surface. The system may include a mount that is attached to a wall, floor or other structure to fix the mount and other system components in location relative to the surface. A positioning assembly may be coupled to the mount, which assembly can support or otherwise hold the tool adjacent the surface and move the tool relative to the surface. The positioning assembly may move the tool into and out of contact with the surface, or otherwise find a reference location and move the tool to an operating position.

The positioning assembly may include a reference location device and a calibrated movement device. The mount may provide a fixed base for the reference location device and the calibrated movement device. The calibrated movement device may be operable to move the tool to a reference position and the reference location device may be operable to identify such reference position, either by a technician's visual confirmation or by an automated means. The calibrated movement device may be operable to move the tool a specified distance from the reference position to an operating position.

The reference location device may include a load cell, such as a strain gauge, and an indicator coupled to the strain gauge. The reference position may be identified, e.g., when the indicator detects a contact of a tip of the tool with the surface. Such contact of the tool tip with the surface may be distinguished from friction of the tool as it is moved along other structure. For example, a fitting that is operable to lock the tool in place in an operating position may, in a release condition nonetheless contact the tool and provide some resistance to movement. By selecting a minimum force, strain, or weight as an identifier of the tool tip's contact with the surface, the contact may be identified and distinguished from friction. Such minimum weight may be a percentage of the weight of the object that defines the surface.

The calibrated movement device may be a micrometer that includes a body, a spindle, a mechanism for effecting a movement of the spindle relative to the body, and an indicator of the movement of the spindle. The mount may include a micrometer holder to receive the body of the micrometer and to fix the body in position relative to the mount. A first loading surface of the strain gauge may be coupled to the spindle of the micrometer, in which case, a second loading surface of the strain gauge is typically coupled to the tool.

A process for using the system may include moving the tool, using the calibrated movement device, until the reference position is identified by the reference location device. Then, the process may include moving the thermocouple, using the calibrated movement device, the specified distance to the operating position.

### BRIEF DESCRIPTION OF THE DRAWINGS

FIG. 1 is a side view (not to scale) of an embodiment of the present invention, showing the system attached to a wall adjacent a reactor chamber with a susceptor inside the chamber and a thermocouple extending into the chamber adjacent the susceptor, and showing a micrometer held by the mount, a strain gauge mounted to the micrometer spindle, and a clamp mounted to the strain gauge and holding the thermocouple, which is shown in solid lines in an operating position and in dashed lines in a reference position.

FIG. 2 is a schematic view of the system with the the micrometer and strain gauge operating to define the reference position for a tool at a reference surface and to move the tool to the operating position.

FIG. 3 is a schematic view of the system similar to FIG. 2, showing an alternative relative position for the micrometer and strain gauge.

FIGS. 4-17 show preferred embodiments of components of the system. FIG. 4 is a perspective view of a mount for attaching the system to a reactor wall.

FIG. 5 is a front view of the mount of FIG. 4.

FIG. 6 is a side view of the mount of FIG. 4.

FIG. 7 is a perspective view of a holder to be coupled to the mount and to hold the micrometer body.

FIG. 8 is a top view of the holder of FIG. 7.

FIG. 9 is a side view of the holder of FIG. 7.

FIG. 10 is a side view of the holder of FIG. 7.

FIG. 11 is a perspective view of a plate to couple the micrometer spindle to the strain gauge.

FIG. 12 is a top view of the plate of FIG. 11.

FIG. 13 is a side view of the plate of FIG. 11.

FIG. 14 is a perspective view of an assembled tool holder.

FIG. 15 is a perspective view of a clamp of the tool holder of FIG. 14.

FIG. 16 is a top view of the clamp of the tool holder of FIG. 14.

FIG. 17 is a perspective view of a base of the tool holder of FIG. 14.

FIG. 18 is a top view of the tool holder base of FIG. 17.

FIG. 19 is a side view of the tool holder base of FIG. 17.

### DETAILED DESCRIPTION

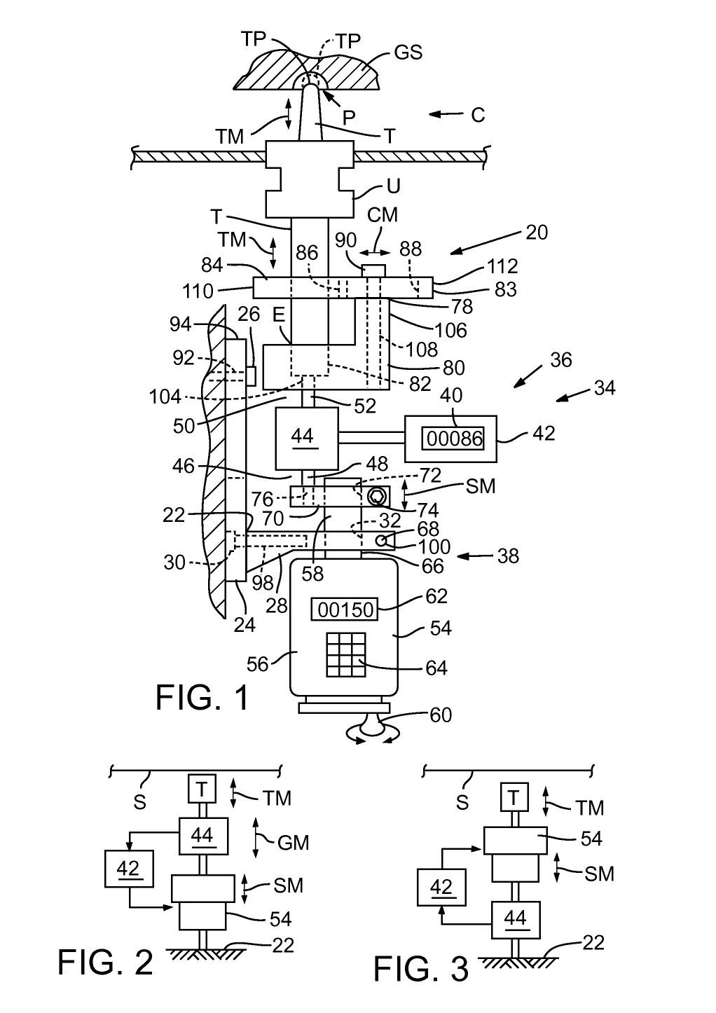

As shown in FIG. 1, a system, indicated generally at 20, may be provided for positioning a tool T relative to a surface S. In a particular application of system 20, surface S may be in a pocket P of a graphite susceptor GS that is placed in a chamber C of a reactor R for processing wafers. System 20 may include a mount 22 fixed in location adjacent surface S, e.g., by bolting or otherwise fastening to a wall W of reactor R. Other structure may be used to provide a fixed location for mount 22, such as a floor or beam and other fastening mechanisms may be used to provide either a single fixed location or an adjustable range of fixed locations.

Mount 22 may include a bracket 24 coupled to wall W, e.g., by bolts, screws, wing nuts or other fasteners 26, and mount 22 may be permanently affixed or temporarily affixed for a tool positioning process. A holder 28 may be coupled to bracket 24, e.g., by bolts 30. Holder 28 may provide a collar-style mount 32 or any other suitable clamp or attaching apparatus.

A positioning assembly 34 may be coupled to mount 22. Positioning assembly 34 may be configured to support tool T adjacent surface S. Positioning assembly 34 typically includes a reference location device 36 and a calibrated movement device 38. Generally speaking, mount 22 provides a fixed base for reference location device 36 and calibrated movement device 38. Calibrated movement device 38 may be operated to move tool T, while it is held by the positioning assembly, to a reference position. An example of a reference position, where a tip TP of tool T is in contact with surface S, is shown in dashed lines in FIG. 1.

With tip TP in the reference position, reference location device 36 preferably is operable to identify the reference position, e.g., by providing on a display 42 an indication 40 of a pressure, strain, or weight or other result of the contact between the tool tip and the surface. Such indication may be perceived visually by a technician and acted on. Alternatively, the indication may be made through an electronic or other feedback loop to the calibrated movement device for automated operation.

In a preferred embodiment of the invention, reference location device 36 includes a load cell, such as strain gauge 44. An indicator, such as display 42, may be coupled to strain gauge 44. Typically, the indicator and the load cell are operable to detect the reference position, such as at a contact of tool T with surface S. Strain gauge 44 typically includes a first loading surface 46 and a first coupling screw 48 and a second loading surface 50 and a second coupling screw 52.

Preferably, the strain gauge measures applied force as the tip of the TC pushes against the susceptor in the reference position. Display 42 may indicate when a predetermined load or force has occurred. In a preferred embodiment, the value for the predetermined set point is a percentage of the weight of the susceptor and is large enough to discount nominal friction that may occur in moving the TC along other components, such as an Ultra Torr nut, U, or other fitting in contact with the TC or other moving components.

Strain gauge 44 may be a commercially available silicon or metal foil strain gauge. Examples of such strain gauges are available from the Futek Corporation and Omega Engineering, Inc. (www.futek.com and www.omega.com, respectively). As one example, the LSB200 strain gauge of Futek may be used with the IPM500 signal conditioner and digital display. The technician may use the display and/or a pre-set alarm to receive the indication of reaching the reference point, and/or an automated indication may be integrated with the calibrated measurement device.

In a preferred embodiment, calibrated movement device 38 includes a micrometer 54 having a body 56, a spindle 58, a mechanism, such as handle 60, for effecting a movement SM of spindle 58 relative to body 56. Micrometer 54 typically includes an indicator 62 that displays translational (extension and retraction) movement SM of spindle 58. Preferably, spindle 58 does not rotate while extending or retracting. Micrometer 54 may also include controls, such as keypad 64, including a control to zero the display of movement SM of spindle 58. Body 56 of micrometer 54 may include a portion 66 defining a neck or other structure that may be received in micrometer holder 28 at collar mount 32, and securely fastened, e.g., by bolt 68. Generally speaking holder 28 receives a portion of body 56 of micrometer 54 and fixes body 56 in position relative to mount 22. A suitable micrometer may be selected for satisfactory quality and accuracy and resolution capability from those available commercially Mitutoyo Corporation and L.S. Starrett Company (www.mitutoyo.com and www.starrett.com, respectively). In a preferred embodiment, Mitutoyo's model 164-161 electronic micrometer is used.

First loading surface 46 of strain gauge 44 may be coupled to spindle 58 of micrometer 54 by any suitable coupling, typically placing the strain gauge and the spindle in a secure, immobilized relation to one another to avoid measurement errors. In a preferred embodiment, a plate 70 couples micrometer spindle 58 to strain gauge 44. Plate 70 may include a collar 72 to receive and hold micrometer spindle 58. A bolt 74 may be used to secure plate 70 onto spindle 58. Plate 70 may include a threaded hole 76 to receive first coupling screw 48 of strain gauge 44. Such coupling is intended to fix strain gauge 44 in position relative to micrometer spindle 58.

Second loading surface 50 of strain gauge 44 may be coupled to tool T by any suitable coupling, typically placing the strain gauge and the tool in a secure, immobilized relation to one another to avoid measurement errors. In a preferred embodiment, a tool holder 78 may be coupled to second loading surface 50 of strain gauge 44. Tool holder 78 may include a base 80 and a clamp 83 that receive tool T and fix the tool in position relative to micrometer spindle 58 and strain gauge 44. These structures and the strain gauge may allow a relative movement between the tool and the spindle, which relative movement is designed to be sufficiently small so as not to affect the proper positioning of the tool within a desired tolerance.

Tool T may have a substantially elongate shape defining tip TP that is positioned relative to surface S and an opposite end E with a substantially cylindrical shape. Tool holder 78 is designed to secure tool T for various shape and may take the preferred form described here or any form suitable for a particular tool. For the elongate, cylindrical shape, tool holder 78 may include on base 80 a cylindrical hole 82 to receive end E of tool T. Clamp 83 may include a clamping bar 84 defining a U-shaped opening 86 above hole 82 in base 80. U-shaped opening 86 is typically shaped and sized to receive tool T adjacent end E of the tool. Clamping bar 84 may include a slot 88 and a releasable fastener, such as bolt 90, coupling bar 84 through slot 88 to base 80 of tool holder 78. In such embodiment, slot 88 and bolt 90 are operable to allow a movement CM of bar 84 relative to base 80 to clamp tool T for different sizes and shapes of tool T.

As shown and described, calibrated movement device 38 is operable to move tool T, as indicated by arrows TM, to the reference position, at which the display 42 so indicates and the micrometer is zeroed. Calibrated movement device 38 is also operable to move tool T a specified distance from the reference position to an operating position. The technician may read such specified distance on display 62 of micrometer 54 while using handle 60 to move tool T. Alternatively, an automated control for micrometer 54 may move tool T the specified distance.

Typically, micrometer 54 is attached at mount 22, and strain gauge 44 is coupled to the micrometer spindle, so that strain gauge 44 moves relative to mount 22, as shown for FIGS. 1 and 2 (arrows GM). Alternatively, strain gauge 44 may be attached to mount 22 and fixed in location, with the micrometer body coupled to the strain gauge and only the spindle and tool moving relative to the mount, as shown in FIG. 3. In either case, display 42 and the technician, or other feedback loop, allow for control of micrometer 54 in view of identification of the reference position.

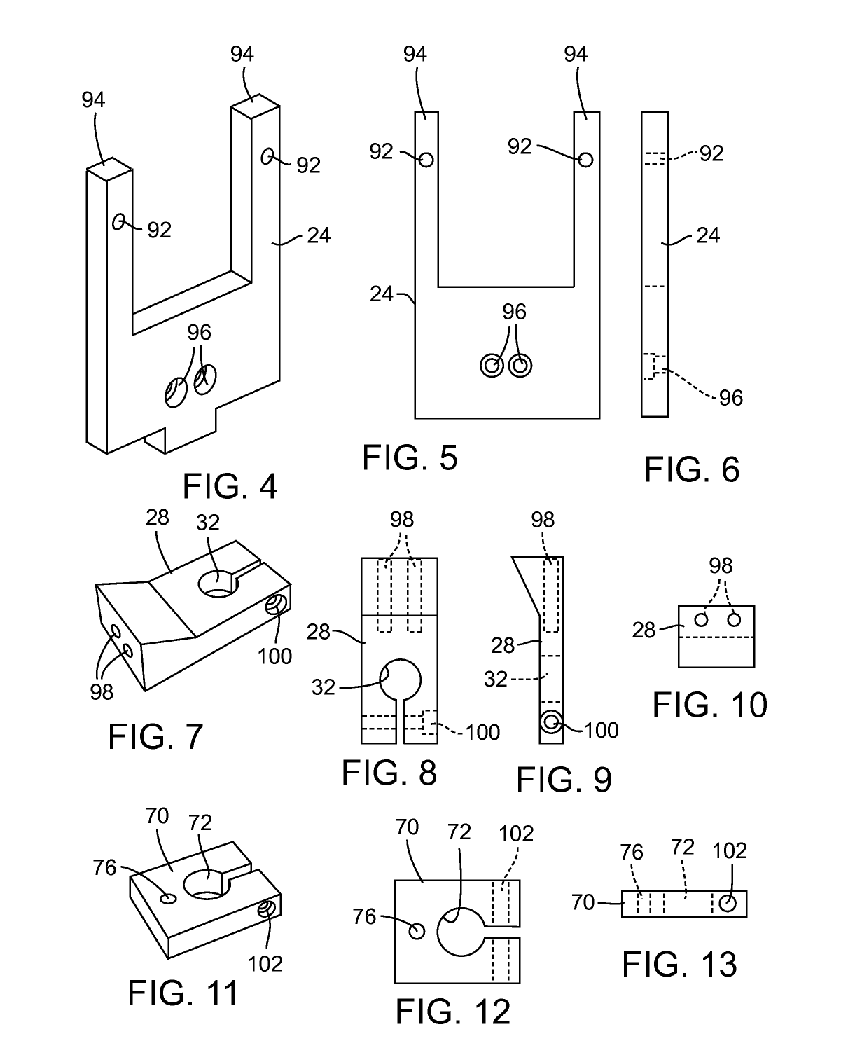

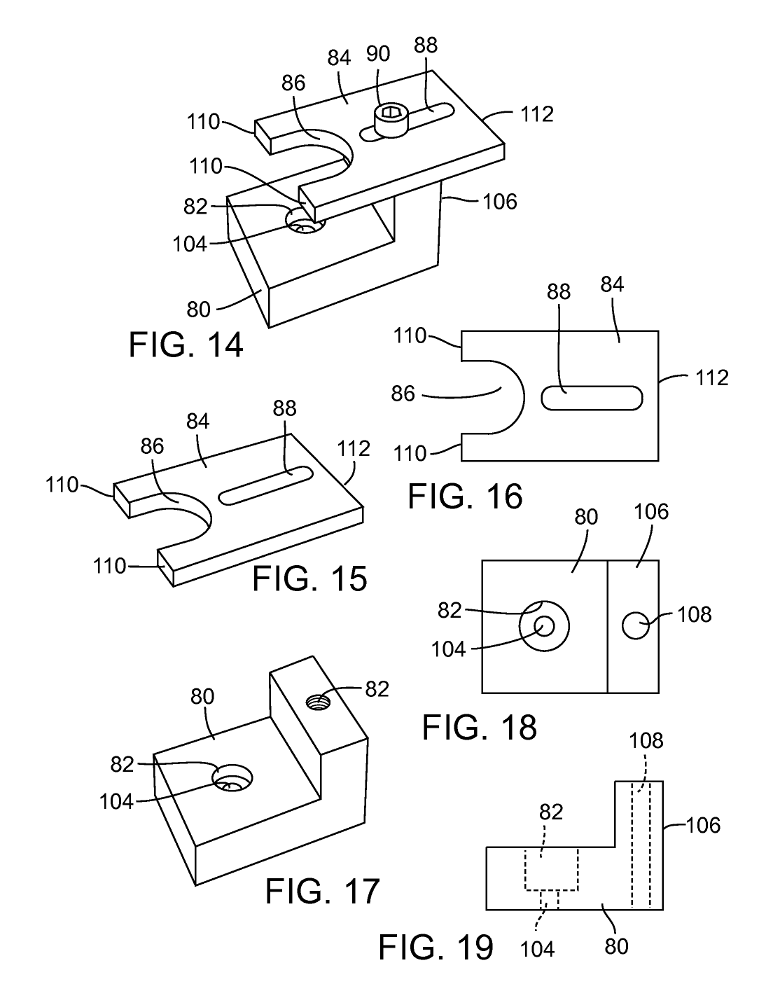

Preferred embodiments for the mechanical mounting fixtures are shown in FIGS. 4-19 and described below, all of which fixtures may be made of aluminum or other suitable material for a particular environment and associated structure. Bracket 24 and other parts of mount 22 (FIGS. 4-10) provide the interface of the system to reactor R and also includes micrometer holder 28 with collar 32 that attaches to the micrometer body. Plate 70 (FIGS. 11-13) interfaces the strain gauge and the micrometer. Tool holder 78 (FIGS. 14-19) interfaces the tool to the strain gauge.

Mount 22 preferably includes as bracket 24 a block of aluminum 0.5-inches thick with a perimeter footprint 3.6-inches long by 4.88-inches high. Two holes 92 for reactor mounting are placed 3.1-inches apart toward the top and each centered on an arm 94. Holder 28 for mounting the micrometer attaches to the aluminum block of bracket 24 via two holes 96, 0.595-inches apart, centered on bracket 24 and approximately 4.25-inches vertically below the horizontal axis of the top mounting holes 92. Extraneous material of the aluminum block is removed as suitable for a particular reactor placement adjacent other structure.

Holder 28 attaches to bracket 24 with two ¼-20 screws 30 (FIG. 1) into two holes 98. The hole center of collar 32 for micrometer placement is offset from bracket 24 by 1.4-inches and a hole 100 is provide for bolt 68 to tighten the collar on the micrometer neck 66.

Plate 70 is aluminum material with 0.25-inches thickness. Strain gauge 44 is screw mounted through hole 76 that is located on plate 70 such that the strain gauge's vertical center axis is aligned with the vertical axis of the TC and 1.25-inches away from the facing surface of bracket 24. Plate 70 includes a hole 102 for bolt 74 to tighten collar 72 on micrometer spindle 58.

Tool holder 78 is a two part construction, made of aluminum. The bottom part, base 80, is a block 1.22-inches×0.875-inches×0.4-inches thick. A lower hole 104 in base 80 is width centered and length offset by 0.177-inches, and 0.125-inches in diameter for receiving screw 52 at second loading surface 50 of strain gauge 44. On the upper side of base 80, hole 82, which is in communication with hole 104, is 0.35-inches in diameter and 0.281-inches deep to allow for clearance of a protruding metal nipple of TC plug end E, which is a manufacturing characteristic of the TC. At the length end opposite of holes 82 and 104, tool holder 78 extends 0.468-inches high in a block extension 106 that is 0.32-inches wide. A vertical hole 108, 0.138-inches in diameter, is centered in block extension 106 and threaded for 6-32 UNF.

The second part of tool holder 78 is clamp 83, including clamping bar 84 for securing the TC. Overall dimension of clamping bar 84 is 1.34-inches×0.87-inches×0.125-inches. One end has a cutout, such as U-shaped opening 86 with a concave radius of 0.25-inches. The radius center is offset inward by 0.18-inches from an edge 110 of bar 84. At an opposite edge 112 of bar 84, slot 88 extends parallel to the bar length, beginning 0.1-inches from bar edge 112 and extending 0.55-inches. Slot 88 is 0.138-inches wide with radius ends of 0.069-inches. Bar 84 attaches to base 80 of tool holder 78 via a 6-32 screw 90 through slot 88 and threaded into 6-32 hole 108 on block extension 106 of block 80.

A typical process for using the preferred embodiment in an ASM Bernouilli reactor includes the following steps:
1. The center TC is installed, and secured in place approximately 1 inch below susceptor GS with Ultra Torr nut U.
2. The system for positioning the TC is mounted to reactor R via mounting holes 92 of mount 22 and secured in place with wing nuts 26.
3. The center TC is released, by loosening the Ultra Torr nut, and allowed to rest on the tool holder 78 and the TC is secured to tool holder 78 with clamping bar 84.
4. The signal conditioner/digital display 42 is powered on.
5. Micrometer spindle 58 is manually extended upward until signal conditioner display 42 indicates the tool tip is in contact with the susceptor surface.
6. Micrometer measurement display 62 is reset to zero.
7. Micrometer spindle 58 is retracted until proper gap distance is obtained.
8. The center TC is secured in place by tightening the Ultra Torr nut.
9. Clamp bar 84 is removed from the center TC and micrometer spindle 58 is retracted until the positioning system has enough clearance to be removed from the reactor.
10. The positioning system is removed from the reactor.
11. The signal conditioner/display is powered off and all parts are stored for future use.
   In such a process for use with susceptor GS that defines a weight, and in which the susceptor is held in place in the chamber by its weight, a percentage of the weight of the susceptor may be selected as the identifier for the reference location device for the reference position.

Additionally, although the system for positioning a sensor has been shown and described with reference to the foregoing operational principles and preferred embodiments, those skilled in the art will find apparent that various changes in form and detail may be made without departing from the spirit and scope of such claims as may be placed in a non-provisional application claiming priority to the present application. The present disclosure is intended to embrace all such alternatives, modifications, and variances that fall within the scope of such claims.

The invention claimed is:

1. A system for positioning a tool relative to a surface, the system comprising:
a mount configured to be fixed in location adjacent the surface;
a positioning assembly coupled to the mount and configured to support the tool adjacent the surface, the positioning assembly including a reference location device and a calibrated movement device, wherein the mount provides a fixed base for the reference location device and the calibrated movement device, and wherein the calibrated movement device is operable to move the tool to a reference position, wherein the reference position is defined as a contact of the tool with the surface, and wherein the reference location device is operable to identify the reference position, and further wherein the calibrated movement device is operable to move the tool a specified distance from the reference position to an operating position.

2. The system of claim 1 wherein the reference location device includes a load cell and an indicator coupled to the load cell, the indicator and the load cell operable to detect the contact of the tool with the surface at the reference position.

3. The system of claim 2 wherein the load cell is a strain gauge, including a first loading surface and a second loading surface.

4. The system of claim 3 wherein the strain gauge further includes a coupling screw for each of the loading surfaces.

5. The system of claim 1 wherein the calibrated movement device is a micrometer including a body, a spindle, a mechanism for effecting a movement of the spindle relative to the body, and an indicator of the movement of the spindle.

6. The system of claim 1 wherein the mount includes a bracket for fixing the mount in location.

7. The system of claim 1, wherein the calibrated movement device is a micrometer including a body, a spindle, a mechanism for effecting a movement of the spindle relative to the body, and an indicator of the movement of the spindle, and further including a micrometer holder to receive the body of the micrometer and to fix the body in position relative to the mount.

8. The system of claim 7, wherein the load cell is a strain gauge, including a first loading surface and a second loading surface, and further wherein the first loading surface of the strain gauge is coupled to the spindle of the micrometer and the second loading surface of the strain gauge is configured to be coupled to the tool.

9. The system of claim 8 further including a plate for coupling the micrometer spindle to the strain gauge.

10. The system of claim 9 wherein the plate includes a collar to receive and hold the micrometer spindle.

11. The system of claim 9 wherein the strain gauge includes a first coupling screw, and the plate further includes a hole to receive the first coupling screw of the strain gauge and to fix the strain gauge in position relative to the micrometer spindle.

12. The system of claim 11 further including a tool holder coupled to the second loading surface of the strain gauge.

13. The system of claim 12 wherein the tool holder includes a base and a clamp configured to receive the tool and fix the tool in position relative to the micrometer spindle and the strain gauge.

14. The system of claim 13 for use with the tool, wherein the tool has a substantially elongate shape defining a tip to be positioned relative to the surface and an opposite end with a substantially cylindrical shape, wherein the tool holder includes on the base a cylindrical hole to receive the end of the tool.

15. The system of claim 14 wherein the clamp includes a clamping bar defining a U-shaped opening above the hole in the base, the U-shaped opening configured to receive the tool adjacent the end of the tool.

16. The system of claim 15 wherein the clamping bar includes a slot and a releasable fastener coupling the bar through the slot to the base, the slot and the releasable fastener operable to allow movement of the bar relative to the base to clamp the tool.

17. A positioning system for detecting a reference position wherein a tool is in contact with a surface and for moving the tool a selectable distance relative to the surface, the system comprising:
a mount configured to be fixed in location adjacent the surface;
a micrometer including a body, a spindle, a mechanism for effecting a movement of the spindle relative to the body, and an indicator of the movement of the spindle,
a strain gauge operatively coupled to the micrometer;
a tool holder operatively coupled to the strain gauge, and configured to support the tool adjacent the surface,
wherein the mount provides a fixed base for the strain gauge and the micrometer, and wherein the micrometer is operable to move the tool to a reference position, wherein the reference position is defined as a contact of the tool with the surface, and wherein the strain gauge is operable to identify the reference position, and further wherein the micrometer is operable to move the tool the selectable distance relative to the surface.

18. A method of positioning a tool at a specified distance relative to a surface, wherein the surface is within a chamber, the process comprising the steps of:
providing a mount in a fixed location adjacent the surface;
coupling a positioning assembly to the mount, the positioning assembly including a reference location device and a calibrated movement device, wherein the mount provides a fixed base for the reference location device and the calibrated movement device, and is configured to hold the tool;
coupling the tool to the positioning assembly;
moving the tool, using the calibrated movement device, until the reference position is identified by the reference location device; and
moving the tool, using the calibrated movement device, the specified distance.

19. The method of claim 18 further including the steps of:
providing a releasable fitting adjacent the chamber for selectively fixing in position and releasing the tool;
prior to the step of moving the tool to the reference position, releasing the fitting to allow movement of the tool;
after the step of moving the tool the specified distance, fixing the tool in position, using the fitting.

20. The method of claim 18 for use with a surface that is part of an object that defines a weight, and further wherein the object is held in place in the chamber by its weight, and further including a step of selecting a percentage of the weight of the object as an identifier for the reference location device for the reference position.
